(19) United States
(12) Patent Application Publication
(10) Pub. No.: US 2021/0182991 A1
(43) Pub. Date: Jun. 17, 2021

(54) AUTOMATED ELECTRONIC TRADE MATCHING SYSTEMS AND METHODS SUPPORTING A NEGOTIATION FRAMEWORK

(71) Applicant: Trumid Technologies, LLC, New York, NY (US)

(72) Inventors: Jason Michael Quinn, Manhasset, NY (US); Anthony John Schiavo, Westfield, NJ (US); Congrui Chen, Watchung, NJ (US)

(21) Appl. No.: 16/710,282

(22) Filed: Dec. 11, 2019

(51) Int. Cl. G06Q 50/18; G06Q 40/06; G06Q 40/02; G06Q 40/04; G06Q 20/10; G06Q 30/06

(52) U.S. Cl. CPC G06Q 50/188; G06Q 40/06; G06Q 30/06; G06Q 40/04; G06Q 20/10; G06Q 40/025

(57) ABSTRACT

Embodiments of the present invention may provide an electronic negotiation framework and data storage system to facilitate the electronic trading of corporate bonds, government bonds, and other semi-liquid financial assets. The electronic negotiation framework may allow two or more market participants to engage each other in an electronic negotiation using numeric responses. These responses may be captured, stored, and then converted into market-standard, conversant messages which are transmitted over a communication network. This electronic “conversation” preferably follows a structured rubric determining the “receive/respond” prompts which enable opposing parties to more efficiently reach mutually agreeable transaction terms. All of these receive/respond messages may be stored in the computer system's database for structured review and analysis.

### RELATED APPLICATION

This application is related to U.S. Utility application Ser. No. 16/422,226, filed May 24, 2019, which is a continuation of, and claims priority to, U.S. Utility application Ser. No. 15/092,990, filed Apr. 7, 2016, now U.S. Pat. No. 10,346,914, which claimed priority to U.S. Provisional Application No. 62/144,056, filed Apr. 7, 2015. The contents of these related applications are incorporated by reference herein in their entireties.

### FIELD OF THE INVENTION

Embodiments of the present invention relate generally to automated electronic trade matching systems and methods for orders to buy and sell fixed income instruments, and in particular, relate to an improved bond trading system and method that supports an electronic negotiation framework.

### BACKGROUND OF THE INVENTION

Conventionally, the trading of corporate bond securities in the marketplace is difficult and inefficient. If an institutional investor wanted to trade corporate bond securities, he or she would have to contact bond market makers (banks) to assist in completing a trade. Then the bank, for instance, would either commit capital to take the other side of said trade, or manually locate an interested party willing to place a bid for the securities in question. The bank, in these cases, effectively operates as a matchmaking party. Unlike publicly-traded stocks, there is no centralized limit order book, (as exists for stocks at venues such as the New York Stock Exchange (NYSE)), through which parties may efficiently trade corporate bond securities. Further, the nature of corporate bonds is far more fragmented than stocks, as issuers of a single, common stock might have tens, or perhaps hundreds, of corporate bond securities, each with varied differentiating criteria. As a result, it is not only difficult to locate two parties that are interested in trading the same corporate bond security, but also who are also willing to trade a particular number of securities at a fair market price.

Indeed, without a centralized market (exchange), it is extremely difficult to ascertain the true fair market prices for a given security. Because trades are created through a manual, private process between two private parties, there is limited pre-trade transparency in the marketplace, making it more difficult to complete trades. Furthermore, interested parties are disincentivized from revealing too much information to other parties in the marketplace out of fear that it would lead to bias or predatory behavior. For example, if a party reveals that he/she is interested in selling a certain security, other parties who gain this information can engage in predatory behavior with respect to that security.

Even if there were a public, centralized marketplace for corporate bond securities, many institutional investors do not have the time to track the market value of particular securities throughout a given day. There remains no viable solution that allows for trades to be completed automatically between two parties at a fair, optimal price while keeping the confidentiality of the parties.

Another shortcoming of prior solutions was the difficulty in locating interested traders in the marketplace, thereby further disincentivizing trades. There remained no central location through which bids and offers may be publicly provided to all interested parties. Thus, even if an institutional investor were interested in placing bids for certain securities, there was no solution that can facilitate the identification of bonds that the trader would likely be interested in, e.g., based on previous transactions, user-definable parameters, and other information.

Yet another shortcoming of prior solutions was their inability to facilitate efficient and effective communications among potential counterparties. Prior systems may provide a “chat” feature by which users converse with each other in an instant-message format. In such systems, the users must type out each message of their conversations in free form, and the states of any negotiation were not tracked. Nor could any successful negotiation be automatically reflected in the execution of a new trade: the counterparties still need to separately set up and execute a new trade presumably in accordance with the agreed terms from the completed negotiation. Thus, such “chat” function merely served as an add-on messaging utility in prior trading systems but was never integrated into or with the core of the electronic trading process.

In view of the foregoing, there are significant problems and shortcomings associated with currently available trading solutions, especially those in the market for corporate bond securities. Accordingly, the inventors recognized a need in the art for an automated electronic trade system to facilitate a negotiation framework for security trades in a variety of transaction types while maintaining party confidentialities.

### SUMMARY OF THE INVENTION

Embodiments of the present invention may provide an electronic trading system or a component or module thereof to support a negotiation framework. The electronic trading system may include a computer memory storing data and instructions, a network interface for communicating with at least two users over a communication network, and at least one computer processor. The at least one computer processor may execute instructions stored in the computer memory to perform the steps of: causing a user interface to be presented on each of the at least two users' client computing devices; and facilitating and recording a negotiation dialog between the at least two users via the user interface based on the following enumerated steps: (1) prompting a first user to input, via the user interface, one or more first numeric parameters indicative of the first user's present interest in an electronic trading transaction concerning a financial instrument, (2) converting, by the at least one computer processor, the one or more first numeric parameters into a first market-standard, conversant message and transmitting the first message to a second user via the network interface and the communication network, wherein a first state concerning the first user is updated, (3) prompting the second user to input, via the user interface and in response to the first message, one or more second numeric parameters indicative of the second user's present interest in the electronic trading transaction concerning the financial instrument, and (4) converting, by the at least one computer processor, the one or more second numeric parameters into a second market-standard, conversant message and transmitting the second message to the first user via the network interface and the communication network, wherein a second state concerning the second user is updated.

Embodiments of the present invention may also provide a computer-implemented method (and related software) for implementing an electronic negotiation framework in connection with an electronic trading system. The method may include: causing a user interface to be presented on each of at least two users' client computing devices; and facilitating a negotiation dialog between the at least two users via the user interface based on the following enumerated steps: (1) prompting a first user to input, via the user interface on the first user's client computing device, one or more first numeric parameters indicative of the first user's present interest in an electronic trading transaction concerning a financial instrument, (2) converting, by at least one computer processor, the one or more first numeric parameters into a first market-standard, conversant message and transmitting the first message to a second user via a communication network, wherein a first state concerning the first user is updated, (3) prompting the second user to input, via the user interface on the second user's client computing device and in response to the first message, one or more second numeric parameters indicative of the second user's present interest in the electronic trading transaction concerning the financial instrument, and (4) converting, by the at least one computer processor, the one or more second numeric parameters into a second market-standard, conversant message and transmitting the second message to the first user via the communication network, wherein a second state concerning the second user is updated. Such negotiation dialog between the at least two users may be continued by repeating these enumerated steps, as needed, until the at least two users reach an agreement on the electronic trading transaction concerning the financial instrument. Upon reaching the agreement, the electronic trading system may automatically execute the electronic trading transaction and then present a confirmation or transaction details to the users.

Embodiments of the present invention may provide a user device. The user device may include: a computer memory storing data and instructions, a network interface configured to communicate with said electronic trading system over a communication network, an input device to receive inputs from a first user, and a display. The user device may also include at least one computer processor executing the instructions stored in the computer memory to perform the steps of: presenting a user interface on said display; prompting said first user to input, with said input device, one or more first numeric parameters indicative of said first user's present interest in an electronic trading transaction concerning a financial instrument; converting, or causing said electronic trading system to convert, said one or more first numeric parameters into a first market-standard, conversant message; and transmitting, or causing said electronic trading system to transmit, said first message to a second user, wherein a first state concerning said first user is updated.

### BRIEF DESCRIPTION OF THE DRAWINGS

In order to facilitate a fuller understanding of the present invention, reference is now made to the accompanying drawings, in which like elements are referenced with like numerals. These drawings should not be construed as limiting the present invention, but are intended to be exemplary only.

FIG. 1 is a block diagram illustrating an operating environment for an electronic trading system in accordance with an embodiment of the present invention.

FIG. 1A is a block diagram illustrating an exemplary electronic trading system that may support a negotiation framework in accordance with an embodiment of the present invention.

FIG. 2 is a block diagram of a user device in accordance with an embodiment of the present invention.

FIG. 3 is a block diagram of a trading server in accordance with an embodiment of the present invention.

FIGS. 4A-C is diagram of a user interface in accordance with embodiments of the present invention.

FIG. 5 is a diagram of a search interface in accordance with an embodiment of the present invention.

FIG. 6 is a block diagram illustrating an exemplary method for implementing an electronic negotiation framework in accordance with an embodiment of the present invention.

FIG. 7 is a diagram illustrating an exemplary negotiation status state machine in accordance with an embodiment of the present invention.

FIGS. 8A-F are tables listing exemplary negotiation messages in accordance with embodiments of the present invention.

FIGS. 9A-M are screenshots illustrating exemplary negotiation messages via a user interface in accordance with embodiments of the present invention.

### DETAILED DESCRIPTION OF THE INVENTION

### Automated Electronic Trading System

Embodiments of the present invention may provide users with an automated electronic trade matching system for orders to buy and sell fixed income instruments or other semi-liquid financial instruments (or similar).

Embodiments of the present invention may generate block-sized liquidity in the corporate securities market by providing traders with execution mechanisms that limit information leakage and help to establish best-execution parameters. Embodiments of the present invention may incentivize subscribers to enter unbiased, executable orders in their maximum desired size while discouraging and taming predatory behavior. Embodiments of the present invention may prevent individual subscriber order information from being revealed to other parties unless needed to facilitate the execution and clearance/settlement of subscriber orders or required by law or regulation.

Embodiments of the present invention may be applicable with respect to various types of securities, including, but not limited to debt securities (e.g., corporate bonds, government bonds, money market instruments, etc.); equity securities (e.g., common stock, preferred stock); derivative securities (e.g., forwards, futures, options, swaps, collateralized debt obligations, credit default swaps, and mortgage-backed securities, etc.), and any hybrids. These securities may be traded on any primary or secondary markets. In one embodiment, the system facilitates the trading of corporate bond securities. For instance, all bond securities designated for trading may be eligible for odd-lot, round-lot, and mixed-lot executions.

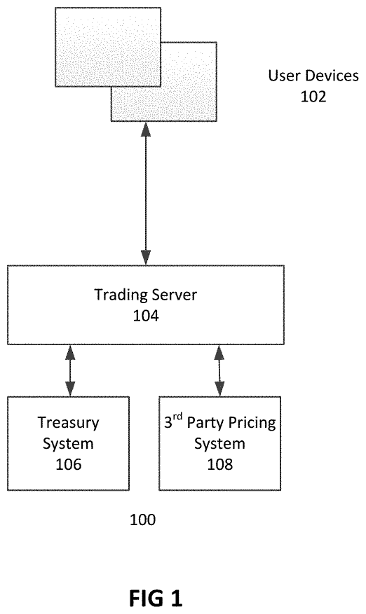

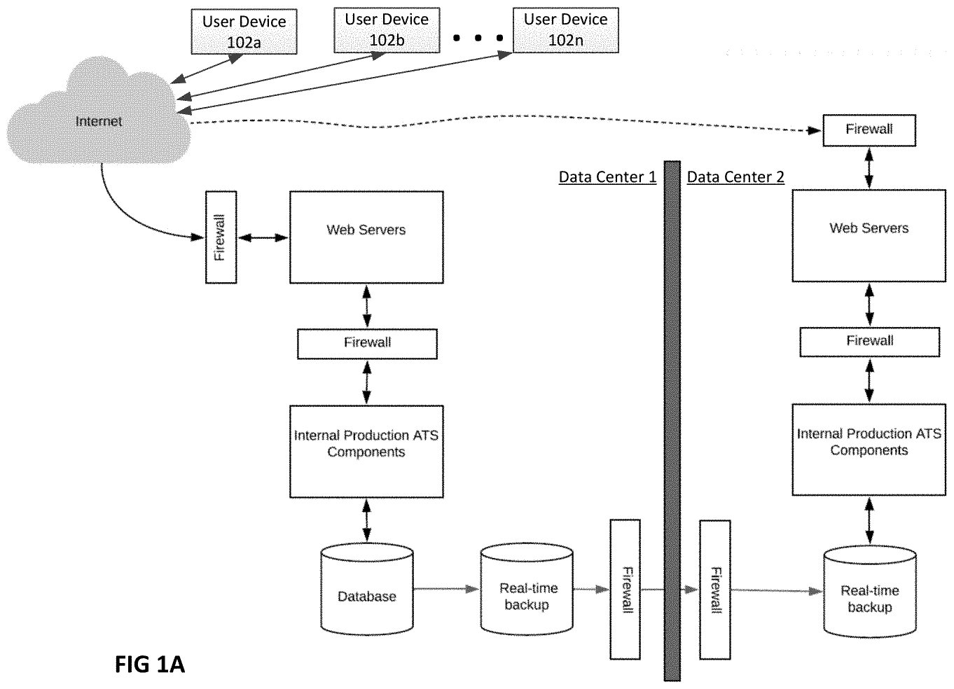

FIG. 1 is a block diagram illustrating an operating environment for operation of an electronic trading system 100 in accordance with an embodiment of the invention. The electronic trading system 100 may include a plurality of user devices (i.e., client computing devices) 102, a trading server 104, a treasury system 106, and a third-party pricing system 108. Additional systems or devices may be included in the operating environment.

The user devices 102 may be provided as a computing device such as a computer, laptop, tablet, etc. The user devices 102 may also be provided as mobile devices including, but not limited to, mobile smartphones, such as Android® phones and iPhones®, tablets, or hand-held wireless devices such as PDAs, multiprocessor systems, microprocessor-based or programmable consumer electronics, minicomputers, other handheld devices that may now be available or may in the future become available. These user devices 102 may utilize a downloadable app supplied by the trading server 104 for use in conjunction with the electronic trading system.

The user devices 102 may be communicatively connected to the trading server 104 via a communication link. The communication link may be provided by one or more networks, such as the Internet. The network may include may include a wired or wireless local area network (LAN) and a wide area network (WAN), wireless personal area network (PAN) and other types of networks. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

The trading server 104 may interact with the plurality of user devices 102 and may manage transactions between the user devices 102 in accordance with embodiments of the present as further explained herein. The trading server 104 may be communicatively connected to the treasury system 106 to receive treasury information that may be relevant to particular transactions. The trading server may be communicatively connected to the third-party pricing system 108 to receive relevant pricing information to particular transactions.

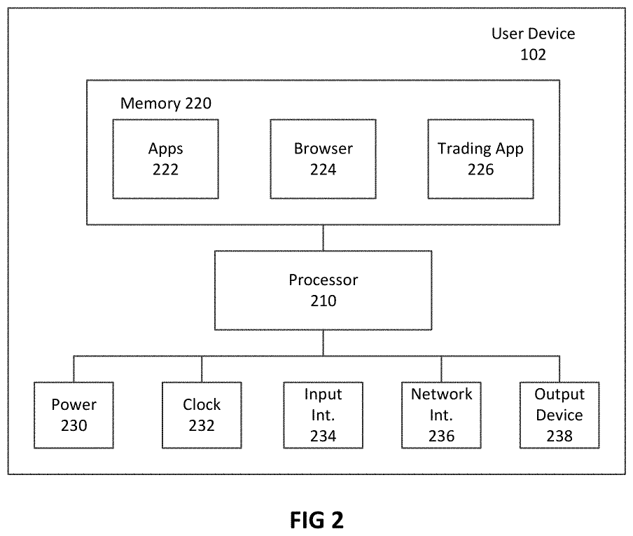

FIG. 2 illustrates a user device 102 in accordance with an embodiment of the invention. The user device 102 may include a processor 210 and a memory 220. The memory 220 may include, for example, applications 222, a browser 224, and a trading application 226. The processor 210 may also be connected to additional components, either stored in a memory or installed as separate hardware components, such as a power source 230, a clock 232, an input interface 234, a network interface 236, and output devices 238.

In embodiments of the invention, users may be required to subscribe to the electronic trading system in order to use the trading application 226. The electronic trading system may link to financial accounts of the subscriber, and therefore the use of a subscription facilitates processing for transactions.

The user device 102 may interact with the electronic trading system 100 using a browser 224 to access an electronic trading system website as will be further described below. Alternatively, the user device 102 may interact with the electronic trading system 100 using a mobile application. In embodiments of the invention, the trading application may cause the subscriber user device to access one or more URLs from the electronic trading system website. In an embodiment, the trading application may provide the ability to automatically take actions based on notifications or other pushed data.

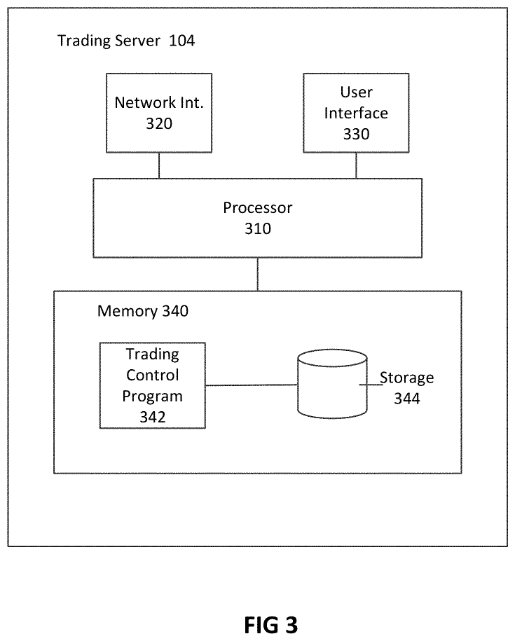

FIG. 3 illustrates a trading server 104 in accordance with an embodiment of the present invention. The trading server 104 may include a processor 310, a network interface 320, a user interface, 330, and a memory 340. The network interface 320 may be used for communicating with the electronic trading system 100 and other systems over a network, and the user interface 330 may allow viewing and input directly by a vendor of the electronic trading system 100. The memory 340 may include a trading control program 342 connected with a storage element 344. The processor 310 may execute various transaction algorithms from the trading control program 342 as will be further described below. The storage element 344 may store data gathered from the various sources described above with respect to FIG. 1, such as from user devices 102. This data may be structured, semi-structured, or unstructured. The data storage areas may include file systems and databases for storing large amounts of data. Data stored in the storage element 344 may be managed and communicated with an Object-Relational Database Management System, as known in the art. The storage element 344 may include multiple data storage areas, which may have different structures and store different types of data. For example, unstructured data may be stored separately from cleansed and structured data.

Embodiments of the present invention provide a marketplace to a plurality of subscribers to facilitate the completion of trades using an application programming interface (API) on the user devices 102 (of FIG. 1) to connect to an exchange. For instance, subscribers may connect a web subscriber portal through a user interface application. Through the user interface, users may perform any number of functions including: view trading hours and support contacts; view relevant System documentation; view counterparty credit limits and balances; view a list of authorized users, their roles, and their associated trading desks; view the trading limits for each of those trading desks; enter and view the Subscriber's orders and trades; access trade history and receive informative market data. Users designated by the Subscriber as an administrator are additionally able to access an administrative portal to add and remove authorized counterparties and set appropriate credit limits; add and remove authorized users and specify their roles on the System; and manage trader, desk, and firm credit limits.

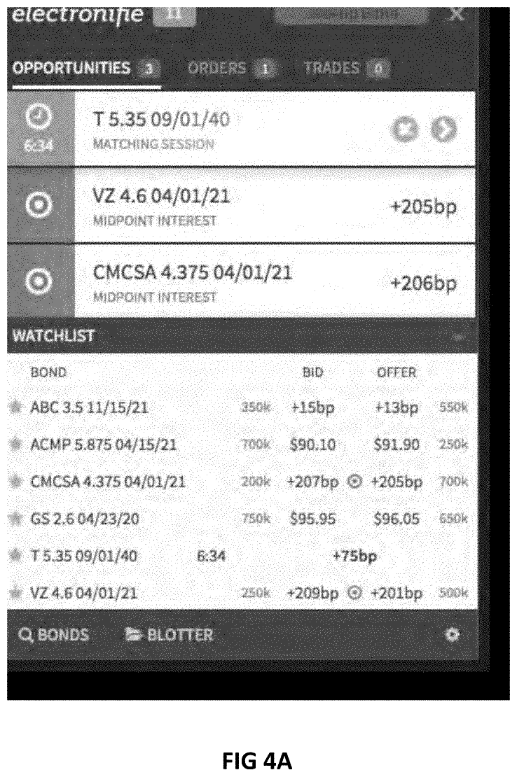

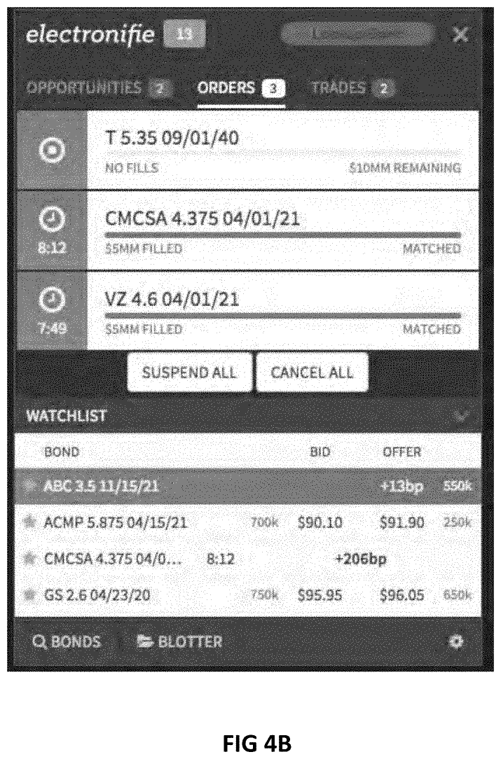

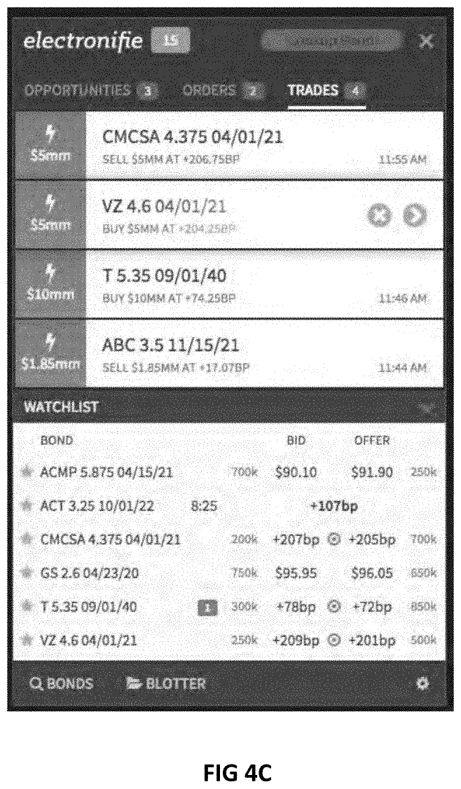

FIGS. 4A-C illustrate a user interface for subscribers in accordance with an embodiment of the present invention. In this embodiment, the user interface may include an opportunities tab; an orders tab; a trades tab; a blotter; and a watchlist. As shown in FIG. 4A, the opportunities tab may provide users with the bids and offers that are available in the marketplace and available with the system. In one embodiment, the user interface may provide offers and bids that are greater than $1 million (or other value set by the system, subscriber or administrator). Thus, these allow institutional bankers to quickly identify high-value offers and bids. The opportunities tab may also provide a subscriber with available bids or offers that may be of interest to the subscriber based on the subscriber's current bids and offers; previous offers, bids, trades; watchlist; or other parameters or attributes. In one embodiment, the user may also be shown matching sessions that are currently active, including the time remaining before expiration. The watchlist provided in the user interface may be configured by the subscriber or administrator and may show the bonds of interest to the subscriber. Thus, this feature provides subscriber with quick access to relevant information, including currently available bids, offers, and the quantity. A blotter may provide user prompts that are based on the activity of other users.

As shown in FIG. 4B, the Orders tab, for example, may depict all active orders and allow a subscriber to suspend or cancel all orders. As shown in FIG. 4C, the trades tab may provide a list of all of the subscriber's executed trades and all active trades of particular bonds.

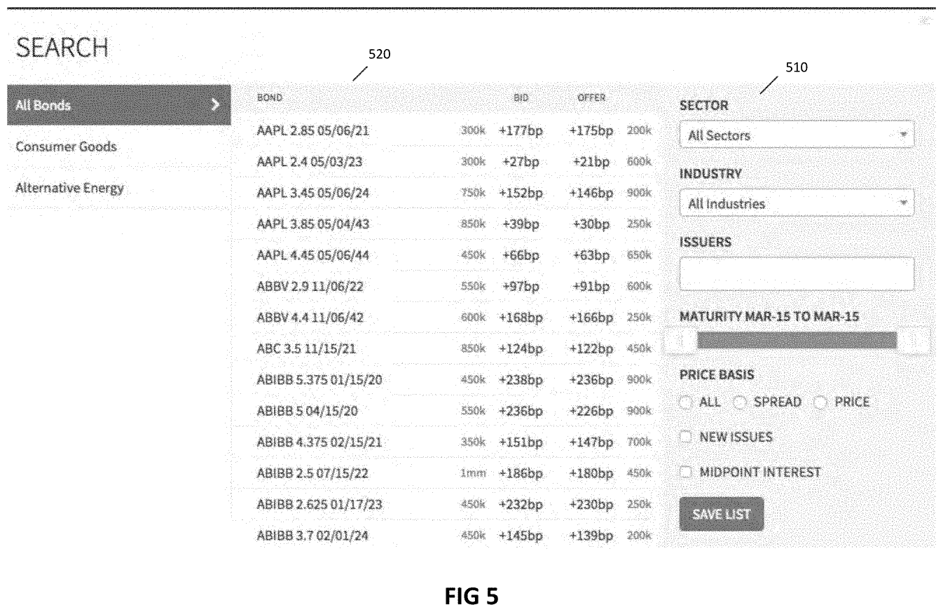

Embodiments of the present invention may also provide a searching function so that the subscriber may search for particular security(ies). FIG. 5 illustrates a searching pane of a user interface in accordance with an embodiment of the present invention. The searching pane may include a fields area 510 and a results area 520. The fields area 510 may include a one or more search fields such as sector, industry, issuers, time range, price, etc. The results area 520 may include a listing of results of the current search.

Embodiments of the present invention may also suggest to subscribers via the user interface particular bid(s) or offer(s) that may be of interest to the subscriber. For instance, a subscriber may be notified that an order has been entered for a security that has one or more characteristics similar to the security or securities in which the subscriber has had or has current interest. In one embodiment, the subscriber may have the ability to fine tune opportunities displayed to them by enabling or disabling characteristics through which similar trading opportunities are presented.

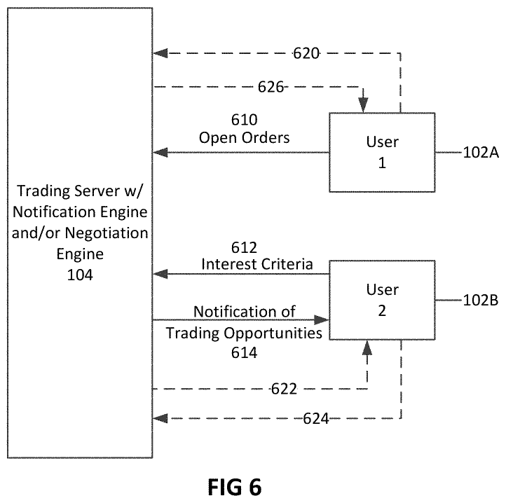

FIG. 6 illustrates a diagram of a notification technique that provides a dynamic notification feature in accordance with an embodiment of the present invention. FIG. 6 depicts a User 1 102a, a User 2 102b, and a trading server 104. The trading server 104 may include a notification engine. In the provided example, the notification engine utilizes data relating to the bonds (or other securities) of interest specified by the subscriber of the system. The notification engine may also collect bond reference data. In step 610, User 1 102a (and other users) may provide information regarding active orders. In step 612, User 2 102b may provide criteria that may be of interest to that subscriber. In an embodiment, a user profile may be created based on preferences of the subscriber and the subscriber's activity history. For instance, the user may specify her preferences such as a list of specific bonds she is interested in trading, specific bonds that she is interested in monitoring, and other criteria (e.g., maturity, industry sectors, credit rating, size of order) that is of interest.

In step 614, the trading server's notification engine may compare attributes of securities of interest specified by User 2 102b with one or more attributes of securities involved in one or more open orders entered by other users (e.g, User 1 102a) in the trading system. For instance, the attribute information collected and considered by the notification engine may include information relating to the issuer, issuer industry, maturity/duration, credit rating, yield/spread/price information, benchmark government bond information, and other relevant information available.

When the notification engine detects an order that may be of interest to User 2 102b, the subscriber may be automatically notified of the trading opportunities, such as in the Opportunities tab of the user interface, as described above in FIG. 4A. In another embodiment of the present invention, the subscriber may be notified through other means, such as through email, text messages, or chat messages. The notification may include a unique URL containing selections on the trading website, wherein selection of the URL may open the subscriber trading application on the user device and allow the subscriber to view available selections on the trading website. These notifications may be received when the subscriber is offline and may bring the subscriber online through selection of the uniquely generated URL. In an embodiment, the notifications may be asynchronous push messages to the user devices.

Embodiments of the present invention may facilitate a variety of transaction types including, but not limited to, midpoint ordering, limit ordering, auction ordering, and matching session ordering. To facilitate the completion of trades, including in an automated and dynamic fashion, embodiments of the present invention may provide subscribers with the capability to complete trades using dynamic mid-market positions and offsets. Specifically, embodiments of the present invention facilitate the creation and completion of orders to buy or sell a specified quantity of a security at a level better than or equal to a specified offset to the current arithmetic average of the best bid and best offer for that security. These orders may be referred herein as “Midpoint Orders,” and the calculated average value of the best (highest) bid and best (lowest) offer for a particular security may be referred herein as a “System Mid.”

According to some aspects of the present invention, an electronic trading system may be provided that includes a computer memory storing data and instructions, a network interface for communicating with at least two subscribers over a communication network, and at least one computer processor. The at least one computer processor may execute instructions stored in the computer memory to perform the steps of: receiving a first set of order parameters for a security transaction from a first subscriber device; storing the first set of order parameters in the computer memory; separating the first set of order parameters into a first subset and a second subset; transmitting the first subset of the order parameters to a second subscriber device over the communication network while maintaining the second subset of the order parameters in the computer memory; receiving a second set of order parameters from the second subscriber device; in response to receiving the first and second set of order parameters, automatic instructions to execute a transaction between the first and second subscribers; transmitting a notification to the first and second subscriber devices over the communication network, the notification allowing access to information about the executed transaction; receiving a selection from the first or second subscriber device regarding the executed transaction; and transmitting information about the executed transaction to display on the first or second subscriber device.

According to some other aspects of the present invention, a user device may be provided that includes an input device to enter order parameters, designating a first subset of the order parameters to be shared with other subscribers and a second subset of the order parameters not to be shared with other subscribers. The user device may also include a communication interface to transmit the order parameters with the subset designations to a trading server over a network, and to receive a notification from the trading server over the network. The user device may further include a display to display the notification, which includes a customized link to a network location with information about a transaction with another subscriber regarding the transmitted order parameters.

According to some further aspects of the present invention, a computer-implemented method for executing a security transaction may be provided that may include the steps of: receiving a first set of order parameters for a security transaction from a first subscriber device; storing the first set of order parameters in the computer memory; separating the first set of order parameters into a first subset and a second subset; transmitting the first subset of the order parameters to a second subscriber device over the communication network while maintaining the second subset of the order parameters in the computer memory; receiving a second set of order parameters from the second subscriber device; in response to receiving the first and second set of order parameters, automatic instructions to execute a transaction between the first and second subscribers; transmitting a notification to the first and second subscriber devices over the communication network, the notification allowing access to information about the executed transaction; receiving a selection from the first or second subscriber device regarding the executed transaction; and transmitting information about the executed transaction to display on the first or second subscriber device.

### Electronic Negotiation Framework

According to preferred embodiments of the present invention, an electronic negotiation framework and data storage system may be implemented to further facilitate the electronic trading of corporate bonds, government bonds, and other semi-liquid financial assets. The electronic negotiation framework may allow two or more market participants, each representing opposing interest (e.g., one as a buyer, the other a seller), to engage each other in an electronic negotiation using numeric responses. These responses may be captured, stored, and then converted into market-standard, conversant prose which is transmitted over a closed, electronic communication network. This electronic “conversation” preferably follows a structured rubric determining the “receive/respond” prompts which enable the opposing parties to more efficiently reach mutually agreeable transaction terms. All of these receive/respond messages may be stored in the computer system's database for structured review and analysis.

Referring back to FIG. 6, there is shown a block diagram illustrating an exemplary method for implementing an electronic negotiation framework in accordance with an embodiment of the present invention. In addition to, or as an alternative to, the notification functions described above in reference to FIG. 6, a negotiation engine may be implemented in connection with the electronic trading server 104 as a component or module integrated therein or coupled therewith. User 1 may use a first client computing device 102A and User 2 may use a second client computing device 102B to communicate with the electronic trading server 104.

The exemplary elements shown in FIG. 6 may be implemented in the operating environment as shown in FIG. 1 or as part of the electronic trading system shown in FIG. 1A. In FIG. 1A, an exemplary electronic trading system is implemented with redundant data centers, Data Center 1 and Data Center 2. User devices (102a, 102b, . . . 102n) may communicate primarily with Data Center 1 during normal operations but may alternatively communicate with Data Center 2 should there be any communication issue with or failover of Data Center 1. The user devices may interact with the web servers of each data center via a first firewall, and the web servers in turn communicate with internal production ATS components through a second firewall. Data Center 1 may store electronic data associated with user accounts, orders, and transactions etc. in a database and maintain real-time backup operations to replicate the database content to Data Center 2. Among the internal production ATS components there may be one or more modules or components that perform the negotiation engine functions (as illustrated in FIG. 6) in support of a negotiation framework in accordance with an embodiment of the present invention.

Referring again to FIG. 6, an electronic negotiation process may start by presenting a user interface on User 1's client computing device 102A. The client computing device 102A, like User 2's client computing device 102B, may be the same as or similar to the one illustrated in FIG. 2 and is typically a personal computer (desktop or laptop), a tablet computer, a smart phone, or other type of computing/communication device including at least a processor, a memory, a network interface, an input device, and a display.

In Step 620, User 1 may electronically indicate his/her present interest to buy or sell a specific security, where User 1 may be referred to as an “Initiator” of an upcoming electronic negotiation dialog. The security may be selected (e.g., interactively via the user interface) from a master security list embedded in the electronic trading system and confirmed by a unique identifier, such as a Committee on Uniform Securities Identification Procedures (CUSIP) number, an International Securities Identification Number (ISIN) or the like. After the security is selected, User 1 (Initiator) may complete all criteria needed to inquire about the purchase or sale of a financial security, including (but not limited to) the size, direction, and price level.

User 1's interest, now represented or indicated by one or more first numeric parameters may be transmitted to the electronic trading server 104 for processing by the negotiation engine (or alternatively at least partially processed by the client computing device 102A) to establish an opening state for User 1 and to generate at least one first market-standard, conversant message based on the resulting, opening state.

Then, in Step 622, the at least one first market-standard, conversant message may be transmitted to User 2's client computing device 102B. Typically, the first message is transmitted to User 2's client computing device 102B through the electronic trading server 104 (as illustrated in FIG. 6). According to an alternative embodiment of the present invention (not shown), the first message may be transmitted directly to User 2's client computing device 102B without involving the server 104, for example, if the first message could be generated by User 1's client computing device 102A.

According to embodiments of the present invention, the communications among the server 104 and the client computing devices (102A, 102B) may be protected with partial or full encryption of the transmitted data.

Upon receiving the first message, the client computing device 102B may display it on a display and prompt User 2 for action. When User 2 (referred to in this context as “Responder”) clicks on the first message, he/she may acknowledge the inquiry via an input device, and the Responder's acknowledgement may be recorded in the server 104's memory. User 2 (Responder) can then reply with at least one numeric counteroffer.

Next, User 2's counteroffer, now represented or indicated by one or more second numeric parameters may be transmitted to the electronic trading server 104 for processing by the negotiation engine (or alternatively at least partially processed by the client computing device 102B) to establish User 2's first state and to generate at least one second market-standard, conversant message.

Then, in Step 624, the at least one second market-standard, conversant message may be transmitted to User 1's client computing device 102A. Typically, the second message is transmitted to User 1's client computing device 102A through the electronic trading server 104 (as illustrated in FIG. 6, Steps 624 and 626). According to an alternative embodiment of the present invention (not shown), the second message may be transmitted directly to User 1's client computing device 102A without involving the server 104, for example, if the second message could be generated by User 2's client computing device 102B.

The electronic negotiation framework may then continue to follow the above-described logical process between the User 1 and User 2, each time modifying the respective user states accordingly, but retaining state histories for future analysis. As states are modified, each market-standard, conversant response may be determined by an expanding polynomial tree and transmitted over the communication network.

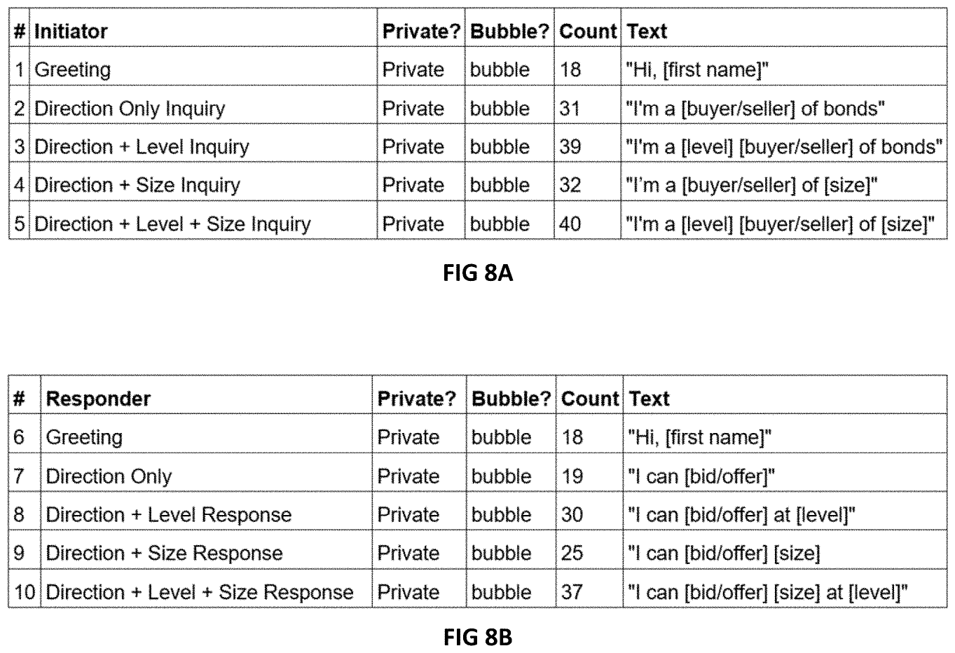

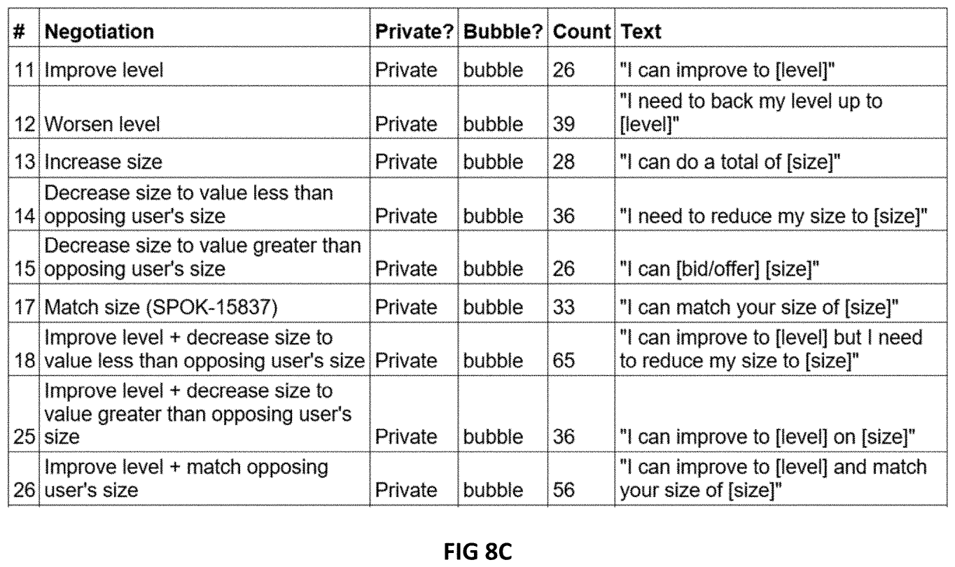

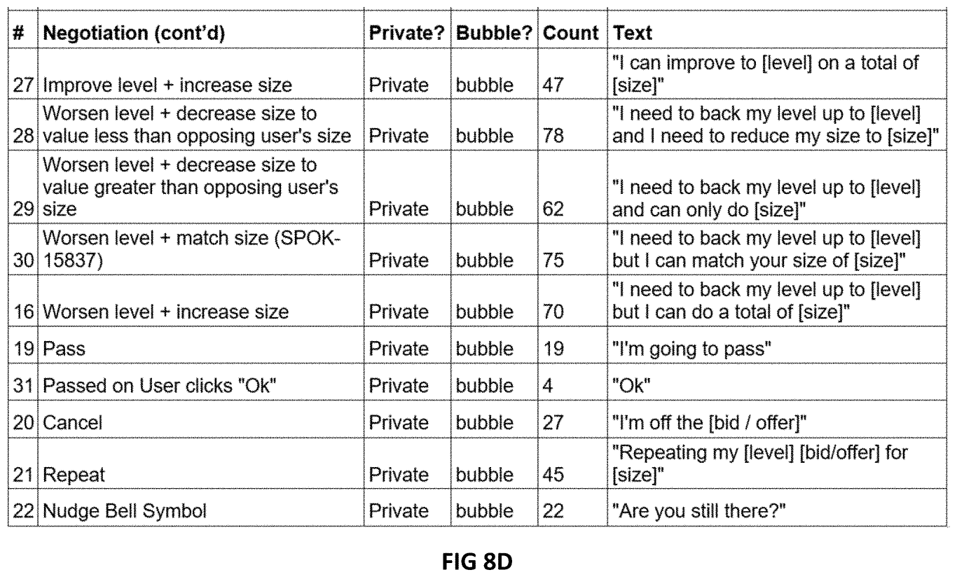

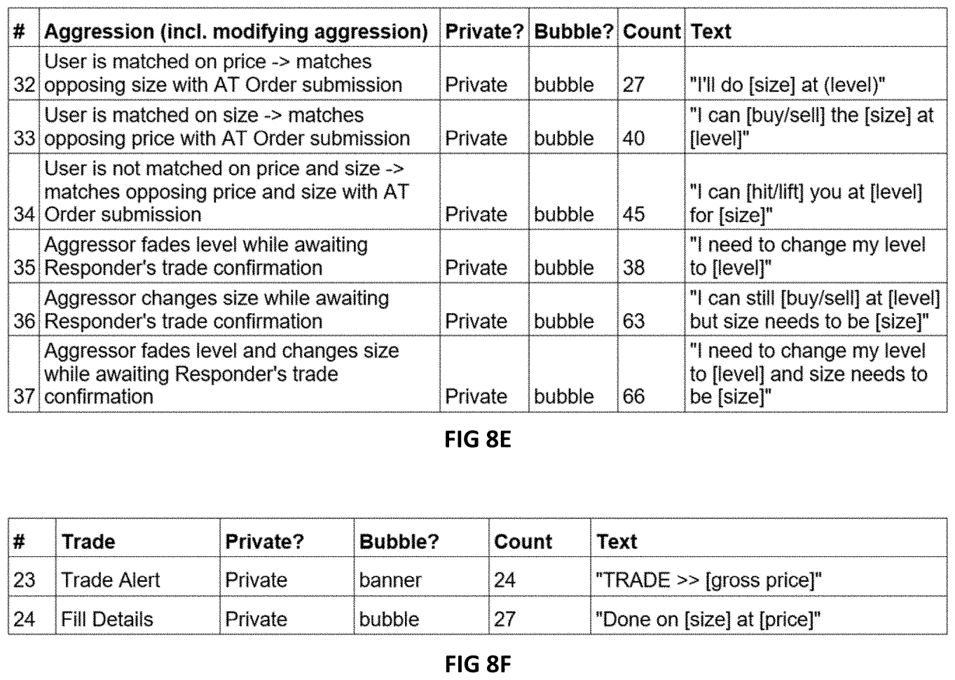

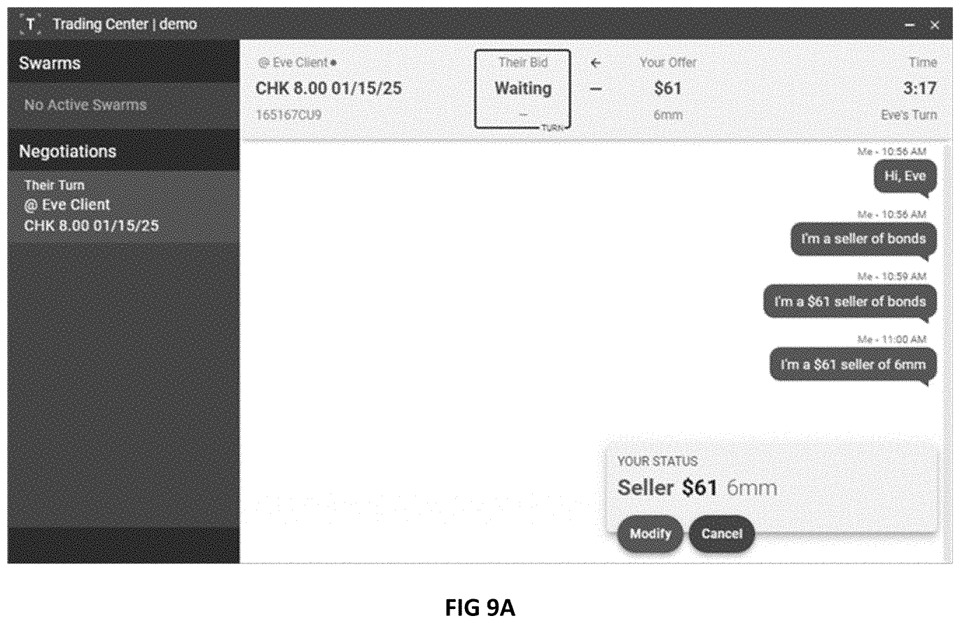

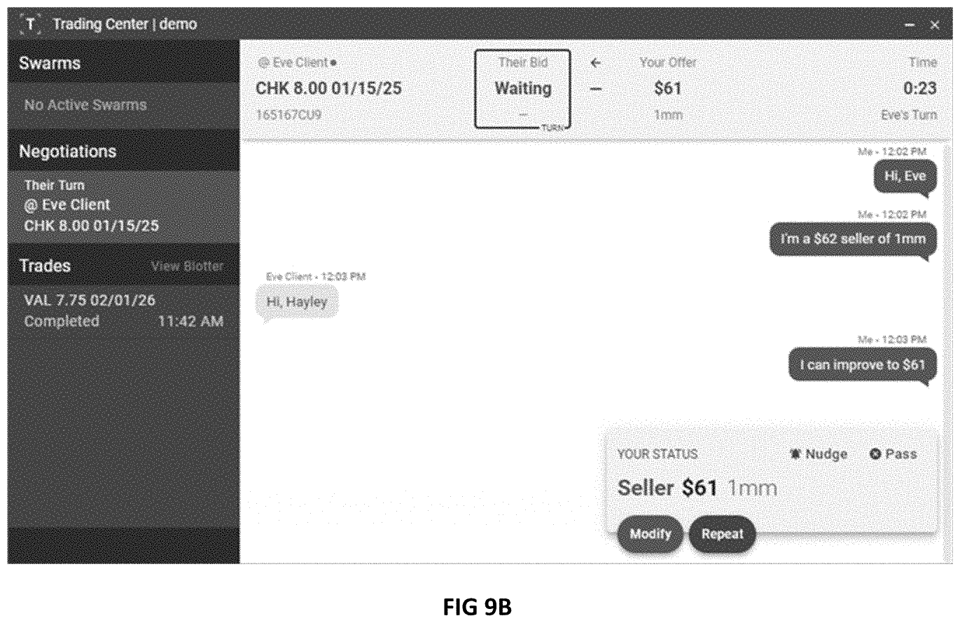

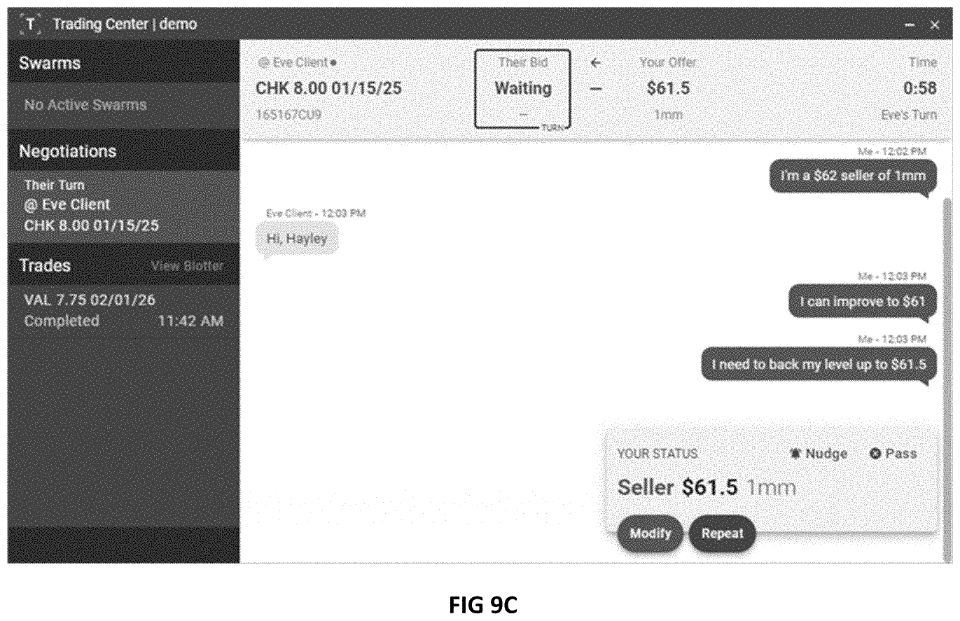

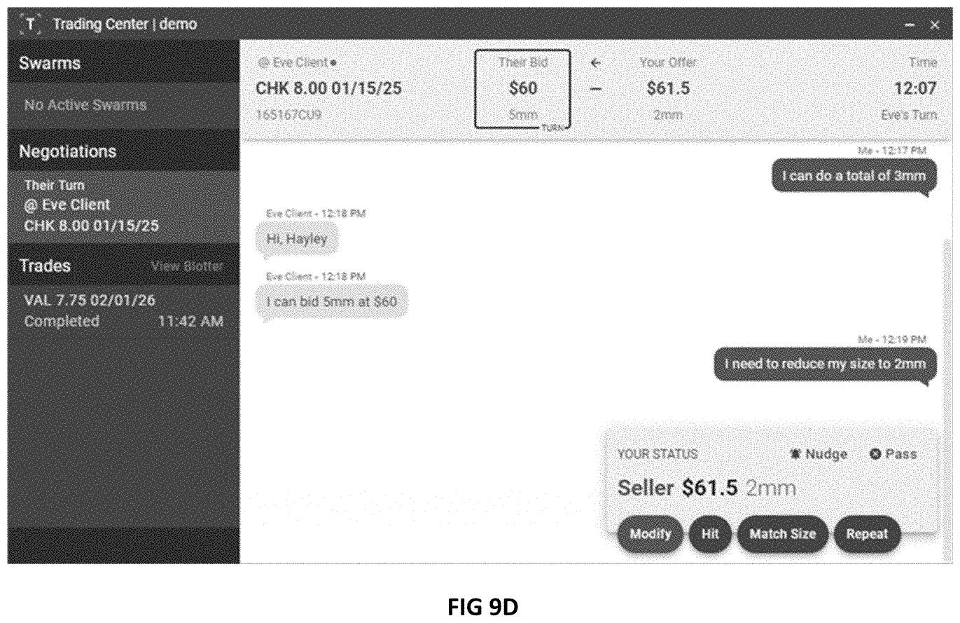

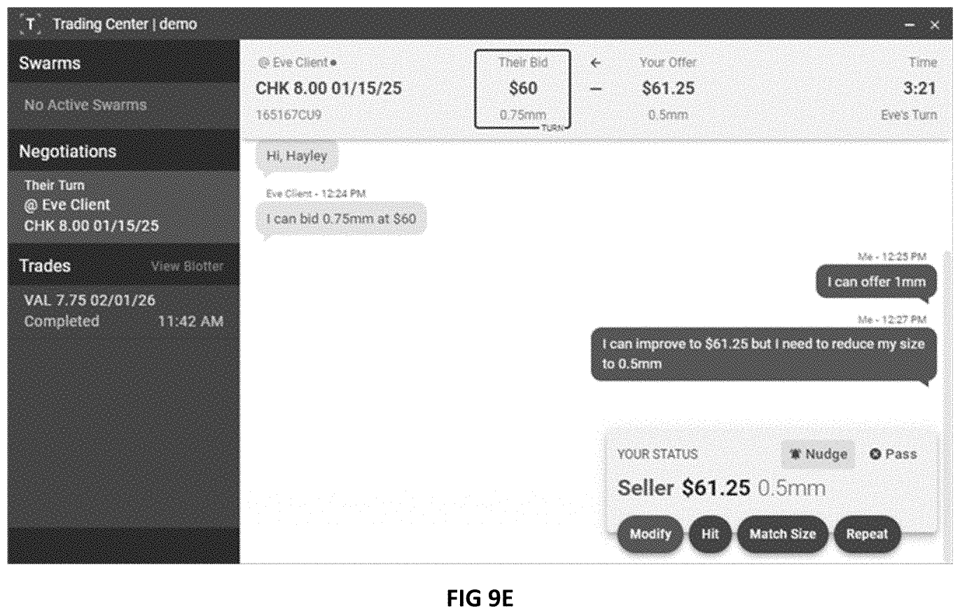

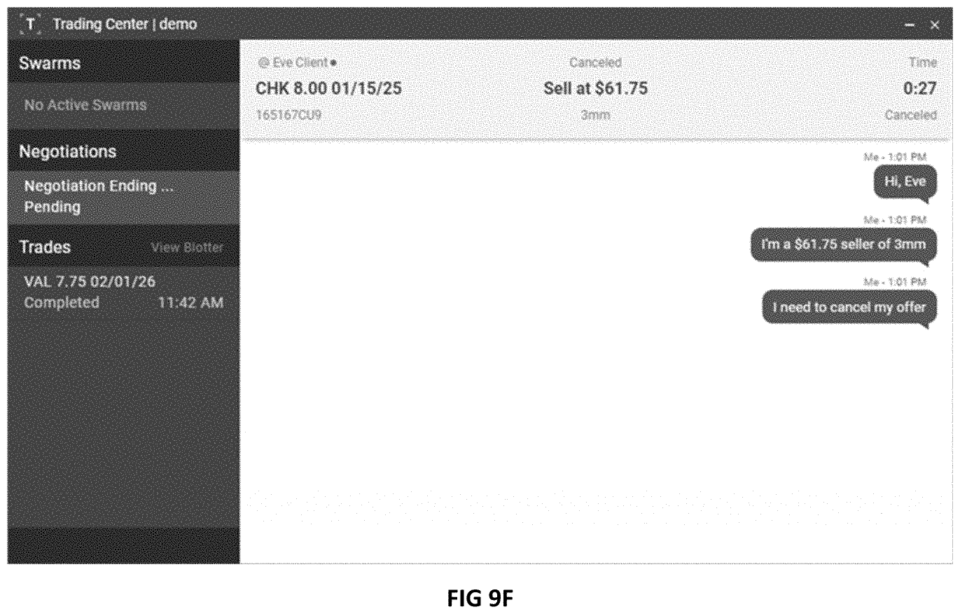

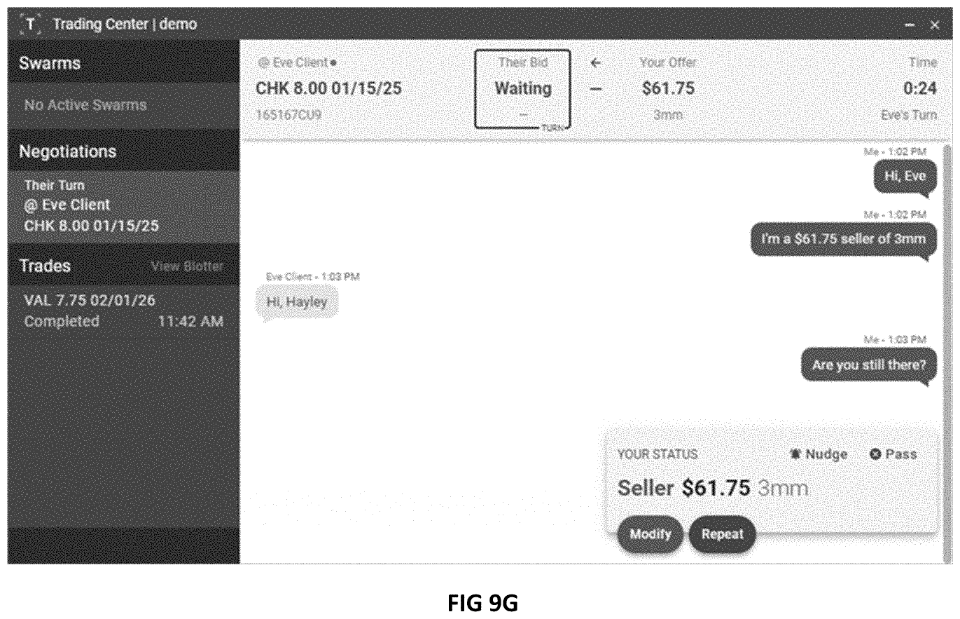

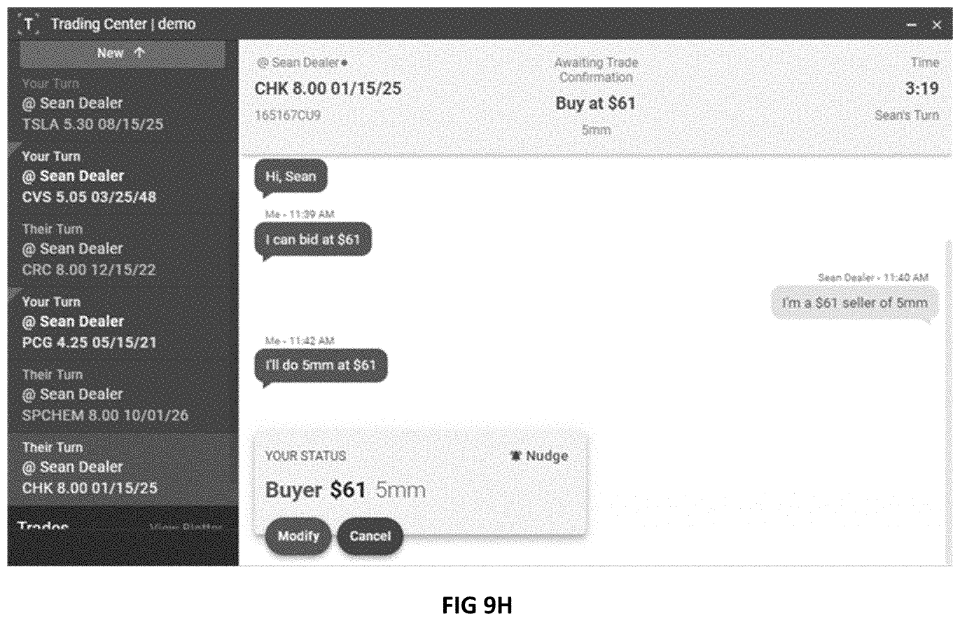

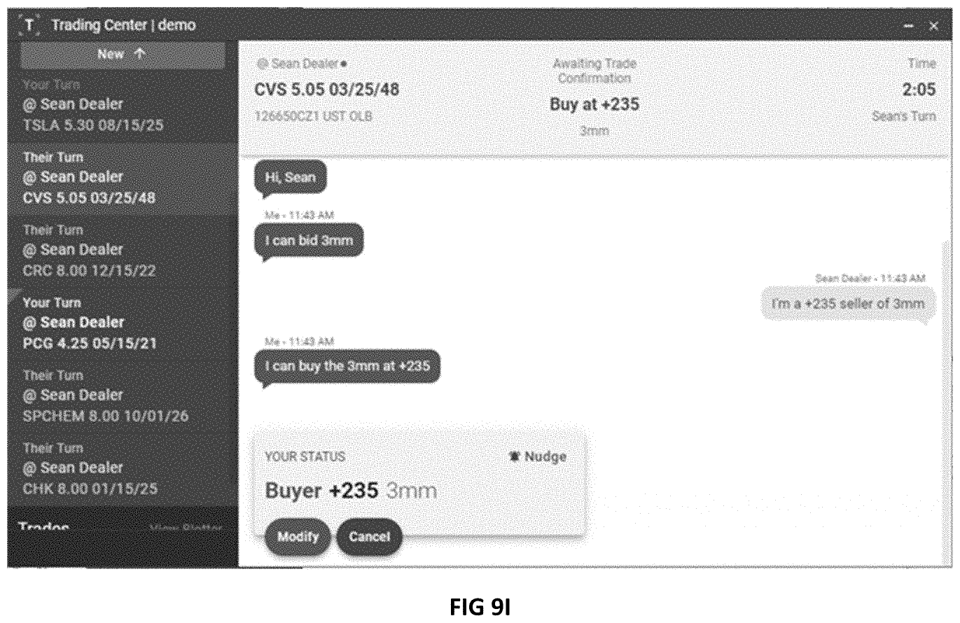

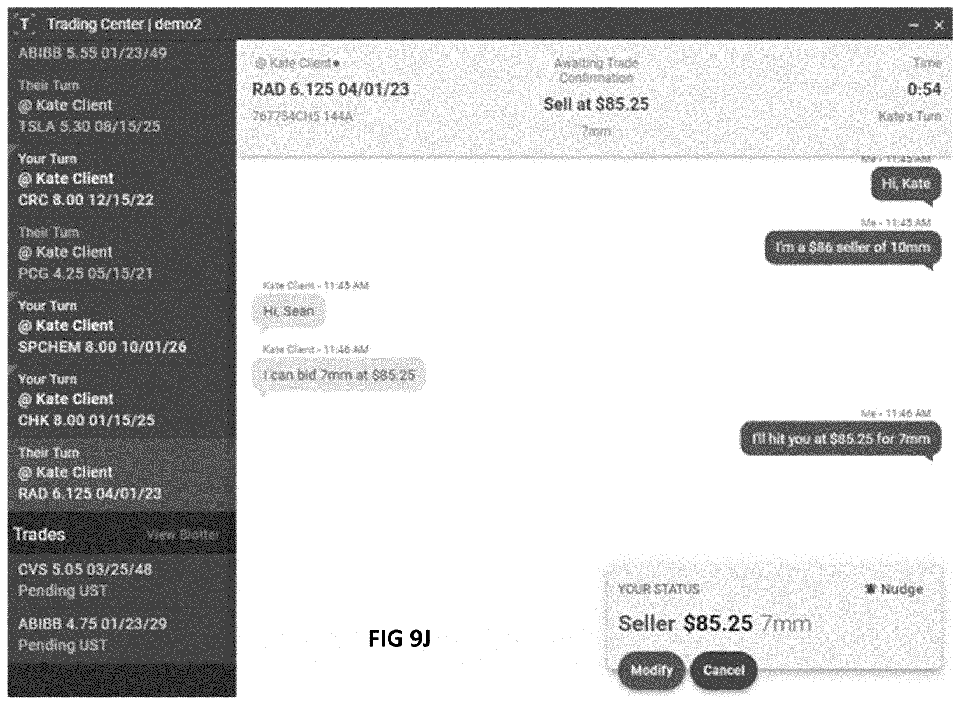

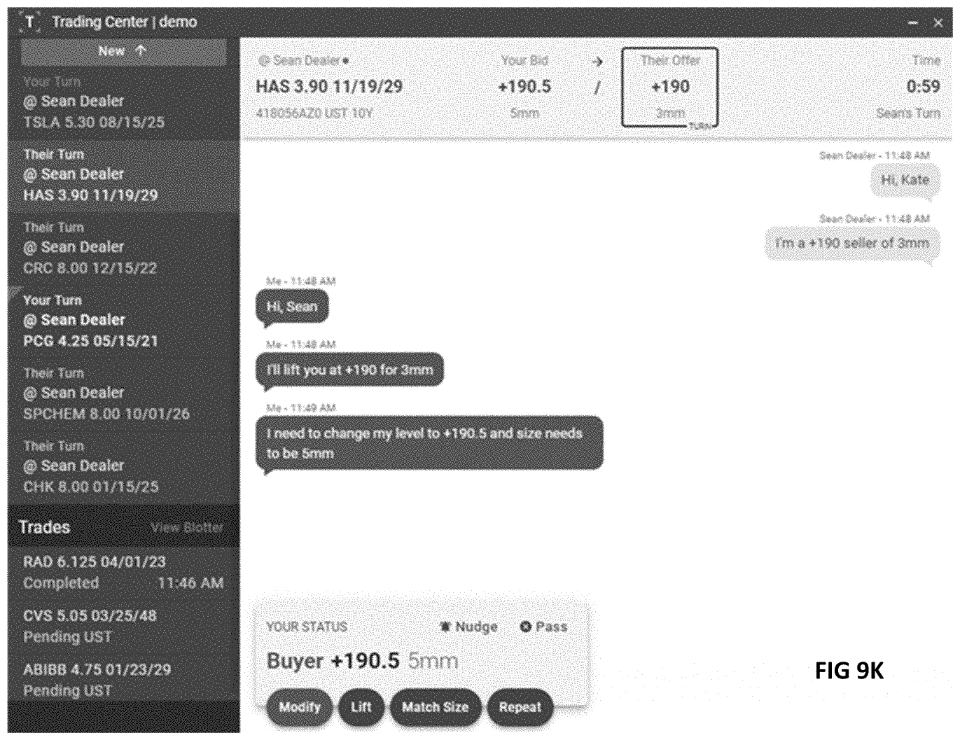

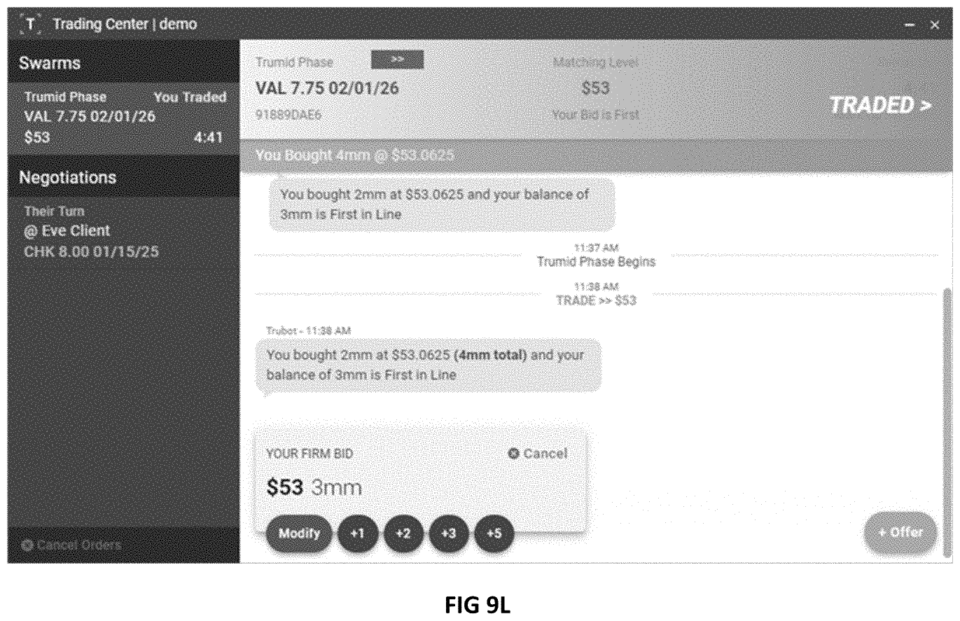

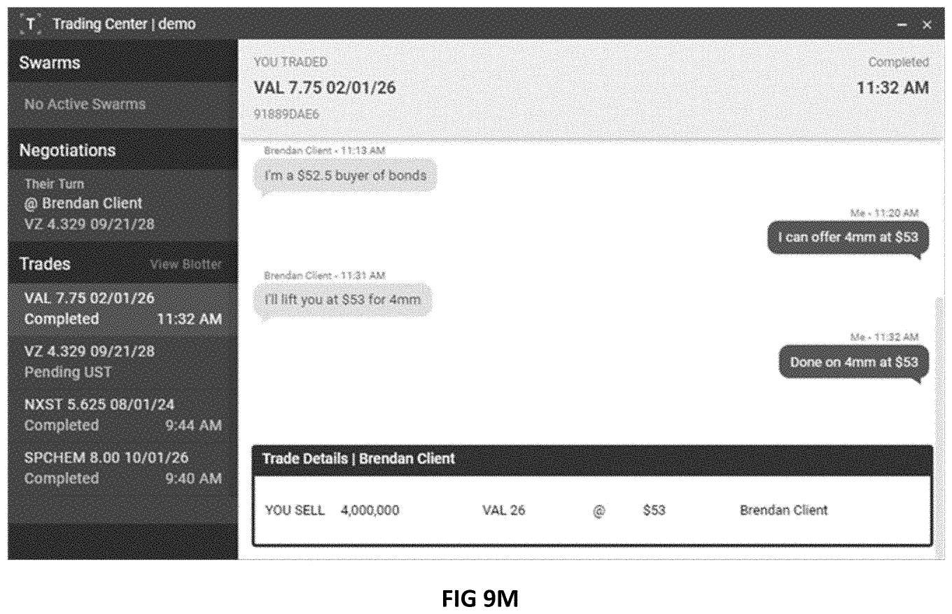

FIGS. 8A-F are tables listing exemplary negotiation messages in accordance with embodiments of the present invention. FIGS. 9A-M are screenshots illustrating exemplary negotiation messages via a user interface in accordance with embodiments of the present invention.

For example, FIG. 8A lists exemplary messages an Initiator may cause his/her client computing device and/or the electronic trading system (or negotiation engine) to generate and transmit to a Responder. Examples of such Initiator messages are shown in FIG. 9A, each as a message bubble in the user interface on Initiator's client computing device (and to be similarly displayed on a recipient's client computing device). These Initiator messages may indicate a present interest in a trading transaction concerning a financial instrument (e.g., a corporate bond) in terms of direction (i.e., buy or sell), size (e.g., units of a bond), and/or price level (e.g., dollar amount per unit). On each user interface, such as shown in FIG. 9A, additional contextual information may be displayed, such as the identity of the financial instrument and the user's own current status. The user may also have the options to modify message(s) or cancel offer(s).

Similar to FIG. 8A, FIG. 8B lists exemplary messages Responder may cause to be generated in response to Initiator messages. Examples of such Responder messages are shown in FIGS. 9B-9D as message bubbles in the user interface.

Following the initial interactions, the parties may continue the negotiation dialog, and the exemplary messages they might cause to be generated based on numeric parameters are listed in FIGS. 8C-8E. Examples of such negotiation messages (including aggression messages) are shown in FIGS. 9B-9K as message bubbles in the user interface. As shown, either party to an ongoing negotiation may be able to modify the terms of his/her offer in either directions (e.g., FIGS. 9B-9E), cancel an offer (FIG. 9F), nudge the other party using a “Nudge” button (FIG. 9G), or engage in aggressions (e.g., FIGS. 9H-9K).

As in any negotiation, the possibility exists for the opposing side's acceptance during any state. For example, in reference to FIG. 6, when User 1's acceptance occurs, the negotiation engine may consume and store User 1's acceptance as the modified state in its memory, then convert the numeric acceptance into a market-standard conversant prose which is transmitted over the communication network to the opposing user, User 2, for his/her acceptance. Following both parties' acceptance, the transaction may be automatically executed by the trading system whereupon the transaction is deemed complete and stored along with the history of both users' states. FIG. 8F lists exemplary messages the parties may receive as the result of executing a trade following successful negotiation; FIGS. 9L and 9M show those messages respectively in an exemplary user interface.

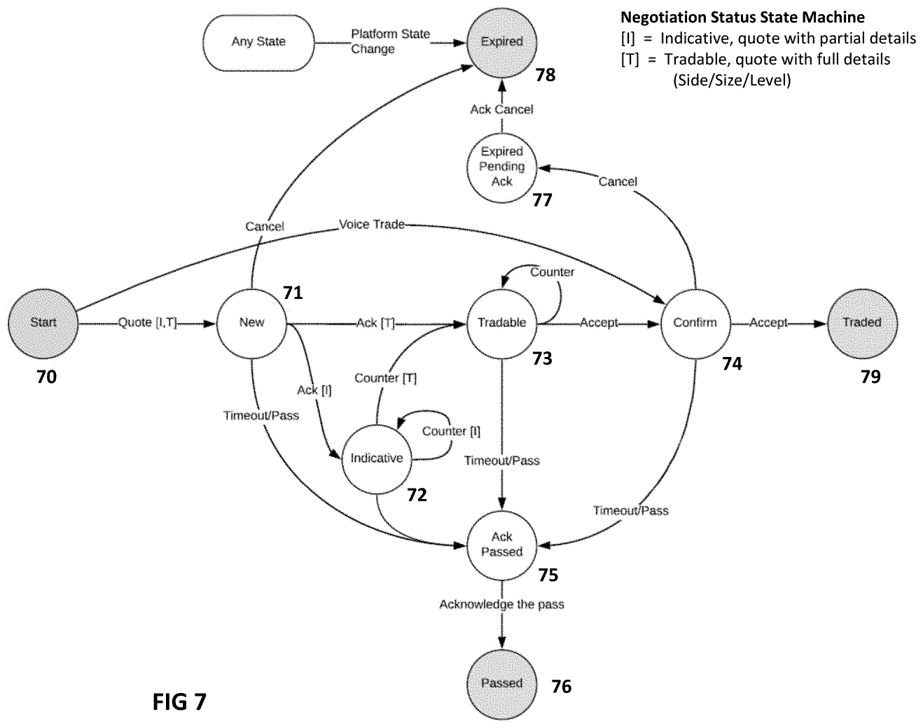

FIG. 7 is a diagram illustrating an exemplary negotiation status state machine in accordance with an embodiment of the present invention. As described above, every time a user expresses or modifies his/her present interest in a transaction or a financial instrument, that user's state may be updated. In an ongoing negotiation, it may be preferable to track the status using a state machine such as shown in FIG. 7.

Starting from “Start” state (70), the offer of an indicative quote (“I”) or tradable quote (“T”) may cause the state machine to transition to the “New” state (71).

In the “New” state (71), if the indicative quote is acknowledged with another indicative offer, then the state machine may transition to the “Indicative” state (72); if the indicative quote is acknowledged with a tradable offer, then the state machine may transition to the “Tradable” state (73). If a defined period of time elapses without any acknowledgement or counteroffer, then the “New” state (71) times out to the “Ack Passed” state (75) that ultimately leads to the “Passed” state (76). In the alternative, the “New” state (71) may transition to the “Expired” state (78) if the indicative offer is canceled.

In the “Indicative” state (72), the parties could keep exchanging indicative offers and counteroffers until there is a tradable counteroffer which takes the state machine to the “Tradable” state (73). Similar to the “New” state (71), the “Indicative” state (72) may also time out to the “Ack Passed” state (75).

In the “Tradable” state (73), one party may either make an counteroffer to the other party or accept the last tradable offer. The acceptance would lead to the “Confirm” state (74) where the acceptance awaits acceptance of the other party. The “Tradable” state (73) may also time out to the “Ack Passed” state (75).

In the “Confirm” state (74), if the other party accepts the acceptance, then the process may proceed to the “Traded” state (79) and the parties' transaction is executed and completed. If the other party does not accept the acceptance, then the “Confirm” state (74) may either time out to the “Ack Passed” state (75) or transition to the “Expired Pending Ack” state (77) if the party offering the acceptance chooses to cancel the offer.

From the “Expired Pending Ack” state (77), the cancellation of the offered acceptance may be acknowledged and the process transitions to the “Expired” state (78).

According to embodiments of the present invention, it may be preferable for the electronic trading system or the negotiation engine to record all historical states of each negotiation regardless of whether they actually led to executed trades. Preservation of the historical states may allow a database of user interactions (i.e., negotiation dialogs) to be built, which, although conversant in their appearance, are in fact, numerical in value. The numerical nature of these data sets may allow for comprehensive analysis, which can become more robust with each interaction (and ensuing historical storage). Whereas previous systems allow for the review of accepted transactions, this state storage system according to embodiments of the present invention can provide a means to analyze both successful and unsuccessful interactions.

### Computer Implementation

The components used in the present invention may be or include a computer or multiple computers. The components may be described in the general context of computer-executable instructions, such as program modules, being executed by a computer. Generally, program modules include routines, programs, objects, components, data structures, etc. that perform particular tasks or implement particular abstract data types.

Those skilled in the art will appreciate that the invention may be practiced with various computer system configurations, including hand-held wireless devices such as mobile phones or PDAs, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

The computer system may include a general purpose computing device in the form of a computer including a processing unit, a system memory, and a system bus that couples various system components including the system memory to the processing unit.

Computers typically include a variety of computer readable media that can form part of the system memory and be read by the processing unit. By way of example, and not limitation, computer readable media may comprise computer storage media and communication media. The system memory may include computer storage media in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by a processing unit. The data or program modules may include an operating system, application programs, other program modules, and program data. The operating system may be or include a variety of operating systems such as Microsoft Windows® operating system, the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, the BeOS™ operating system, the Macintosh™® operating system, the Apache™ operating system, an OpenStep™ operating system or another operating system or platform.

At a minimum, the memory includes at least one set of instructions that is either permanently or temporarily stored. The processor executes the instructions that are stored in order to process data. The set of instructions may include various instructions that perform a particular task or tasks, such as those shown in the appended flowcharts. Such a set of instructions for performing a particular task may be characterized as a program, software program, software, engine, module, component, mechanism, or tool. A plurality of software processing modules may be stored in a memory as described above and executed on a processor in the manner described herein. The program modules may be in the form of any suitable programming language, which is converted to machine language or object code to allow the processor or processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments of the invention. Illustratively, the programming language used may include assembly language, Ada, APL, Basic, C, C++, COBOL, dBase, Forth, FORTRAN, Java, Modula-2, Pascal, Prolog, REXX, and/or JavaScript for example. Further, it is not necessary that a single type of instruction or programming language be utilized in conjunction with the operation of the system and method of the invention. Rather, any number of different programming languages may be utilized as is necessary or desirable.

Also, the instructions and/or data used in the practice of the invention may utilize any compression or encryption technique or algorithm, as may be desired. An encryption module might be used to encrypt data. Further, files or other data may be decrypted using a suitable decryption module.

The computing environment may also include other removable/nonremovable, volatile/nonvolatile computer storage media. For example, a hard disk drive may read or write to nonremovable, nonvolatile magnetic media. A magnetic disk drive may read from or write to a removable, nonvolatile magnetic disk, and an optical disk drive may read from or write to a removable, nonvolatile optical disk such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The storage media are typically connected to the system bus through a removable or non-removable memory interface.

The processing unit that executes commands and instructions may be a general purpose computer, but may utilize any of a wide variety of other technologies, including a special purpose computer, a microcomputer, mini-computer, mainframe computer, programmed micro-processor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID processor, smart chip, or any other device or arrangement of devices that is capable of implementing the steps of the processes of the invention.

It should be appreciated that the processors and/or memories of the computer system need not be physically in the same location. Each of the processors and each of the memories used by the computer system may be in geographically distinct locations and be connected to communicate with each other in any suitable manner. Additionally, it should be appreciated that each of the processor and/or memory may be composed of different physical pieces of equipment.

A user may enter commands and information into the computer through a user interface that includes input devices such as a keyboard and pointing device, commonly referred to as a mouse, trackball or touch pad. Other input devices may include a microphone, joystick, game pad, satellite dish, scanner, voice recognition device, keyboard, touch screen, toggle switch, pushbutton, or the like. These and other input devices are often connected to the processing unit through a user input interface that is coupled to the system bus, but may be connected by other interface and bus structures, such as a parallel port, game port or a universal serial bus (USB).

One or more monitors or display devices may also be connected to the system bus via an interface. In addition to display devices, computers may also include other peripheral output devices, which may be connected through an output peripheral interface. The computers implementing the invention may operate in a networked environment using logical connections to one or more remote computers, the remote computers typically including many or all of the elements described above.

Various networks may be implemented in accordance with embodiments of the invention, including a wired or wireless local area network (LAN) and a wide area network (WAN), wireless personal area network (PAN) and other types of networks. When used in a LAN networking environment, computers may be connected to the LAN through a network interface or adapter. When used in a WAN networking environment, computers typically include a modem or other communication mechanism. Modems may be internal or external, and may be connected to the system bus via the user-input interface, or other appropriate mechanism. Computers may be connected over the Internet, an Intranet, Extranet, Ethernet, or any other system that provides communications. Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths.

Although many other internal components of the computer are not shown, those of ordinary skill in the art will appreciate that such components and the interconnections are well known. Accordingly, additional details concerning the internal construction of the computer need not be disclosed in connection with the present invention.

While the foregoing description includes many details and specificities, it is to be understood that these have been included for purposes of explanation only, and are not to be interpreted as limitations of the present invention. It will be apparent to those skilled in the art that other modifications to the embodiments described above can be made without departing from the spirit and scope of the invention. Accordingly, such modifications are considered within the scope of the invention as intended to be encompassed by the patent claims ultimately issued from this application.

1. An electronic trading system, comprising:
a computer memory storing data and instructions;
a network interface configured to communicate with at least two users over a communication network; and
at least one computer processor executing the instructions stored in the computer memory to perform the steps of:
causing a user interface to be presented on each of the at least two users' client computing devices; and
facilitating and recording a negotiation dialog between the at least two users via said user interface based on the following enumerated steps:
1) prompting a first user to input, via said user interface, one or more first numeric parameters indicative of said first user's present interest in an electronic trading transaction concerning a financial instrument,
2) converting, by said at least one computer processor, said one or more first numeric parameters into a first market-standard, conversant message and transmitting said first message to a second user via said network interface and said communication network, wherein a first state concerning said first user is updated,
3) prompting said second user to input, via said user interface and in response to said first message, one or more second numeric parameters indicative of said second user's present interest in said electronic trading transaction concerning said financial instrument, and
4) converting, by said at least one computer processor, said one or more second numeric parameters into a second market-standard, conversant message and transmitting said second message to said first user via said network interface and said communication network, wherein a second state concerning said second user is updated.

2. The electronic trading system according to claim 1, wherein said negotiation dialog between the at least two users is continued by repeating said enumerated steps, as needed, until the at least two users reach an agreement on said electronic trading transaction concerning said financial instrument.

3. The electronic trading system according to claim 2, being further configured to automatically execute said electronic trading transaction concerning said financial instrument based on said agreement.

4. The electronic trading system according to claim 3, being further configured to present a confirmation and/or details of said executed electronic trading transaction to the at least two users.

5. The electronic trading system according to claim 1, wherein said one or more first numeric parameters and said one or more second numeric parameters are selected from a group consisting of parameters indicative of a direction, a size, and a price level of said electronic trading transaction concerning said financial instrument.

6. The electronic trading system according to claim 1, wherein said at least one computer processor is further configured to track said negotiation dialog between the at least two users based on a state machine.

7. The electronic trading system according to claim 6, wherein said state machine is updated by updating said first state and said second state.

8. The electronic trading system according to claim 1, being further configured to store said one or more first numeric parameters and said one or more second numeric parameters for review or analysis of said negotiation dialog.

9. The electronic trading system according to claim 1, wherein said financial instrument is selected from a group consisting of: corporate bonds, government bonds, and other semi-liquid financial assets.

10. A computer-implemented method for use in connection with an electronic trading system, comprising:
causing a user interface to be presented on each of at least two users' client computing devices; and
facilitating a negotiation dialog between the at least two users via said user interface based on the following enumerated steps:
1) prompting a first user to input, via said user interface on said first user's client computing device, one or more first numeric parameters indicative of said first user's present interest in an electronic trading transaction concerning a financial instrument,
2) converting, by at least one computer processor, said one or more first numeric parameters into a first market-standard, conversant message and transmitting said first message to a second user via a communication network, wherein a first state concerning said first user is updated,
3) prompting said second user to input, via said user interface on said second user's client computing device and in response to said first message, one or more second numeric parameters indicative of said second user's present interest in said electronic trading transaction concerning said financial instrument, and
4) converting, by said at least one computer processor, said one or more second numeric parameters into a second market-standard, conversant message and transmitting said second message to said first user via said communication network, wherein a second state concerning said second user is updated.

11. The computer-implemented method according to claim 10, wherein said negotiation dialog between the at least two users is continued by repeating said enumerated steps, as needed, until the at least two users reach an agreement on said electronic trading transaction concerning said financial instrument.

12. The computer-implemented method according to claim 11, further comprising:
automatically executing, by said electronic trading system, said electronic trading transaction concerning said financial instrument based on said agreement.

13. The computer-implemented method according to claim 12, further comprising:
presenting a confirmation and/or details of said executed electronic trading transaction to the at least two users.

14. The computer-implemented method according to claim 10, wherein said one or more first numeric parameters and said one or more second numeric parameters are selected from a group consisting of parameters indicative of a direction, a size, and a price level of said electronic trading transaction concerning said financial instrument.

15. The computer-implemented method according to claim 10, further comprising:
tracking said negotiation dialog between the at least two users based on a state machine.

16. The computer-implemented method according to claim 15, wherein said state machine is updated by updating said first state and said second state.

17. The computer-implemented method according to claim 10, further comprising:
storing said one or more first numeric parameters and said one or more second numeric parameters in connection with said negotiation dialog.

18. The computer-implemented method according to claim 17, further comprising:
conducting structured review or analysis of said negotiation dialog, regardless of whether said electronic trading transaction is executed, based on said stored one or more first numeric parameters and said stored one or more second numeric parameters.

19. The computer-implemented method according to claim 10, wherein the conversion of said one or more first numeric parameters and said one or more second numeric parameters into said first message and said second message respectively is performed at least in part by the at least two users' client computing devices.

20. The computer-implemented method according to claim 10, wherein said financial instrument is selected from a group consisting of: corporate bonds, government bonds, and other semi-liquid financial assets.

21. A non-transitory computer readable medium comprising instructions for causing at least one computer processor to perform the following in connection with an electronic trading system:
causing a user interface to be presented on each of at least two users' client computing devices; and
facilitating a negotiation dialog between the at least two users via said user interface based on the following enumerated steps:
1) prompting a first user to input, via said user interface on said first user's client computing device, one or more first numeric parameters indicative of said first user's present interest in an electronic trading transaction concerning a financial instrument,
2) converting said one or more first numeric parameters into a first market-standard, conversant message and transmitting said first message to a second user via a communication network, wherein a first state concerning said first user is updated,
3) prompting said second user to input, via said user interface on said second user's client computing device and in response to said first message, one or more second numeric parameters indicative of said second user's present interest in said electronic trading transaction concerning said financial instrument, and
4) converting said one or more second numeric parameters into a second market-standard, conversant message and transmitting said second message to said first user via said communication network, wherein a second state concerning said second user is updated.

22. A client computing device for use in connection with an electronic trading system, comprising:
a computer memory storing data and instructions;
a network interface configured to communicate with said electronic trading system over a communication network;
an input device to receive inputs from a first user;
a display; and
at least one computer processor executing the instructions stored in the computer memory to perform the steps of:
presenting a user interface on said display;
prompting said first user to input, with said input device, one or more first numeric parameters indicative of said first user's present interest in an electronic trading transaction concerning a financial instrument;
converting, or causing said electronic trading system to convert, said one or more first numeric parameters into a first market-standard, conversant message; and
transmitting, or causing said electronic trading system to transmit, said first message to a second user, wherein a first state concerning said first user is updated.
